(19) United States
(12) Patent Application Publication
(10) Pub. No.: US 2006/0056568 A1
(43) Pub. Date: Mar. 16, 2006

(54) Tool for assisting loading of a nuclear fuel assembly inside a nuclear reactor core

(75) Inventor: Michel Jullien, Lucenay (FR)

Correspondence Address: HESLIN ROTHENBERG FARLEY & MESITI PC, 5 COLUMBIA CIRCLE, ALBANY, NY, 12203, US

(73) Assignee: FRAMATOME ANP, Courbevoie (FR)

(21) Appl. No.: 11/099,330

(22) Filed: Apr. 5, 2005

Related U.S. Application Data
(63) Continuation of application No. PCT/FR03/03044, filed on Oct. 15, 2003.

(30) Foreign Application Priority Data
Oct. 15, 2002 (FR) 02.12767

(51) Int. Cl. G21C 19/00

(52) U.S. Cl. 376/268

(57) ABSTRACT

A tool is provided for assisting the loading of nuclear fuel assemblies inside a reactor core. The assemblies have a prismatic shape and square cross-section, and are positioned on a plurality of adjacent locations, likewise with square cross-section, each comprising positioning blocks and orifices for circulating a liquid coolant and in particular water. The tool comprises an actuator which, in retracted positions, has a square requirement less than that of a fuel assembly. The actuator is provided with means for acting at the intermediate fuel assemblies and/or at the intermediate baffles of the reactor vessel of the location concerned at which it is being introduced. The actuator is provided with gripping means designed to cooperate with the grab of a handling mast enabling its insertion at the location concerned.

The invention relates to a tool intended to assist loading or insertion of a nuclear fuel assembly inside a reactor core of a nuclear plant.

In a known manner, the reactor core of a nuclear plant comprises fundamentally a vessel, inside which is positioned a certain number of vertical fuel rod assemblies, placed side by side on a bed, also called a core plate.

These fuel assemblies consist typically of a certain number of needles or rods, made up by the assembly of sintered pellets of actual nuclear fuel, particularly of uranium oxide or plutonium, the rods being held inside one and the same assembly by means of spacer grids, distributed over the height of the assemblies.

These assemblies comprise a top head, allowing the assembly to be grasped and handled inside the reactor, and a foot, providing its positioning and retention on the core plate, the latter being provided for this purpose with orifices or positioning pins, in addition to the orifices allowing the circulation of a liquid coolant, particularly water.

When the assemblies thus constituted are new, they stand straight and therefore cause no particular difficulties with respect to their handling or their installation inside the core plate. On the other hand, after a certain period of irradiation, said assemblies are seen to have different types of formation, such as in particular twists, arched or “banana” deformations, bucklings, these deformations tending to increase greatly with the time or the degree of irradiation, and thus inducing increasing difficulties when the assemblies are placed in the core, or when they are extracted therefrom.

Because of the deformations thus caused in the assemblies, after one or more operating cycles, reinserting them in other sites of the core on the core plate may cause problems, particularly due to interferences in volume with the adjacent assemblies.

In parallel, in order to homogenize the radiation of energy in the volume of the core, the assemblies are placed on the core plate according to their degree of wear or irradiation.

Typically, the core plate is divided into three zones. The new elements are placed at the periphery, the elements that have undergone one operating cycle in the median zone, and the most worn elements at the center of the core, primarily for the purpose of preventing a hot zone in the center of the reactor.

During periodic replacement, the burnt up assemblies are removed for retreatment and are replaced by assemblies originating from the median zone. The assemblies removed from this second zone are replaced by assemblies originating from the periphery, which are replaced by new assemblies.

This typical distribution may also be modified in order to preserve in particular the vessel from too much irradiation originating from the new fuel assemblies.

Whatever happens, the deformation phenomena are increasingly frequent and accentuated due in particular to the lengthening of the irradiation cycles and the change in the methods of producing the assemblies.

Although formerly the deformations appeared in the form of buckling of the cladding causing the arching, likewise “banana” deformation, random deformations of highly diverse. shapes are observed with increasing frequency.

It is therefore easily conceivable that although the movement and placement of the first assemblies pose no problem, on the other hand the placement of the final fuel assemblies presents serious difficulties due to the deformations inherent in the adjacent assemblies, likely to partially obstruct the location or locations intended to receive the final assemblies.

At present the operators proceed with the aid of the grab connected to the main mast of the refueling machine to try to clear the space or the volume necessary to install these assemblies.

These operations however take a particularly long time, are irksome and therefore have an effect on the duration of the plant shutdowns and hence greatly affect the productivity of the plants.

The object of the present invention is to propose a tool capable of assisting the loading of a nuclear fuel assembly inside a reactor core, while ensuring that the volume necessary to install a fuel assembly is cleared relative to the intermediate assemblies already in place on the core plate.

This tool for assisting the loading of nuclear fuel assemblies inside a reactor core, said assemblies having a prismatic shape and square cross section, and being positioned on a plurality of adjacent locations, also with square cross section, each comprising positioning pins and orifices for circulating a liquid coolant and in particular water, is characterized in that it consists of at least one actuator which, in retracted position, has a space requirement less than that of a fuel assembly, said actuator being provided with means intended to act on the intermediate fuel assemblies and/or on the intermediate vessel baffles of the location concerned at which it is being loaded, said actuator being furnished with. gripping means intended to interact with the grab of a handling mast used to load same at the location concerned.

More precisely, the means with which the actuator or actuators is (are) provided act on a plane perpendicular to the main direction of the fuel assembly, and in particular in the four directions cross section of each of the assembly locations, conventionally called North, South, East and West. The action in these four directions may be simultaneous, or be carried out in successive manner two by two, along the North-South and East-West axes.

These means may typically consist of mechanical, electric, pneumatic or hydraulic cylinders. They may be actuated automatically or controlled by means of a control console situated either at the edge of the vessel cavity, or at the refueling machine.

According to a first embodiment of the invention, the tool extends over the whole height of the fuel assembly and can be positioned on the core plate and be anchored thereon, more particularly on the positioning pins with which the latter is provided.

This gives the tool a certain rigidity and a fulcrum point allowing the means with which the actuator is furnished to act more effectively on the intermediate fuel assemblies.

According to another embodiment of the invention, the tool comprises only one actuator intended to act only on the heads of the fuel assemblies.

According to another variant, the tool comprises several actuators distributed over its height, advantageously at the spacer grids of the fuel assemblies. However, considering that it is not rare for there to be assemblies of various origins within one and the same core, the spacer grids are not likely to be all at the same level.

Consequently, the tool is advantageously furnished with pressure distribution metal sheets, that is to say vertical, flat metal plates, particularly made of stainless steel, parallel to the sides of the intermediate assemblies, and extending over the whole height of the tool. These metal sheets are secured to the end of the means with which the actuators are furnished.

In this way, the pressure developed by the actuators is limited and better distributed on the intermediate assemblies.

These metal sheets may be reinforced locally by any appropriate reinforcement device.

The manner in which the invention may be embodied and the advantages which derive therefrom will better emerge from the following exemplary embodiment, given for information only and not limiting, in support of the appended figures.

FIG. 1 is a schematic representation in perspective of the tool according to the invention.

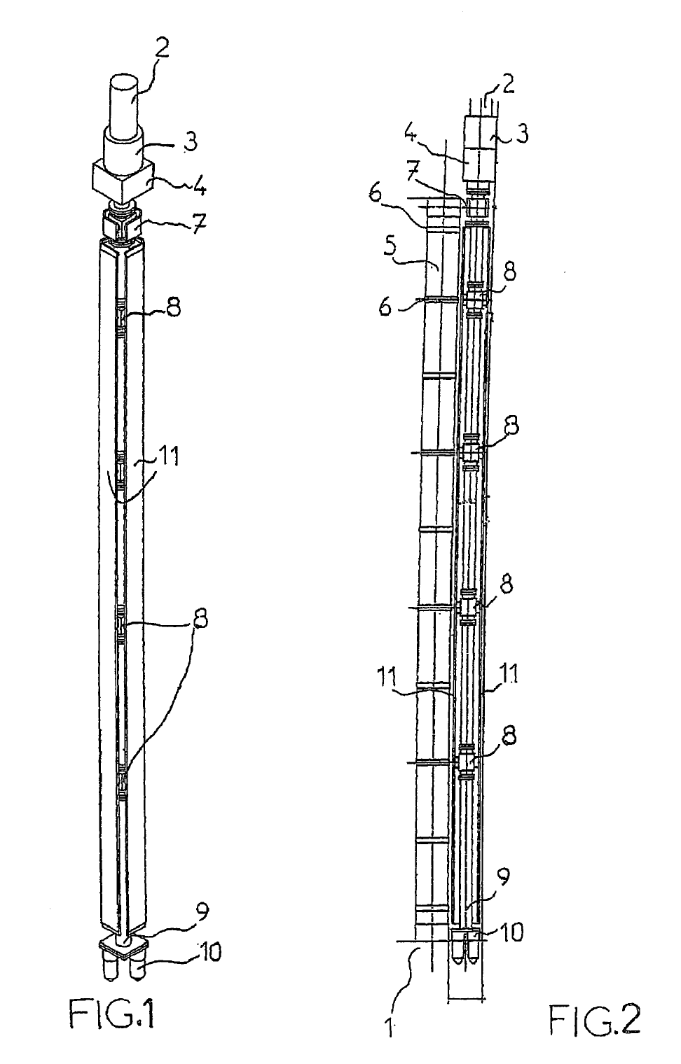

FIG. 2 is a schematic representation in longitudinal cross section of said tool.

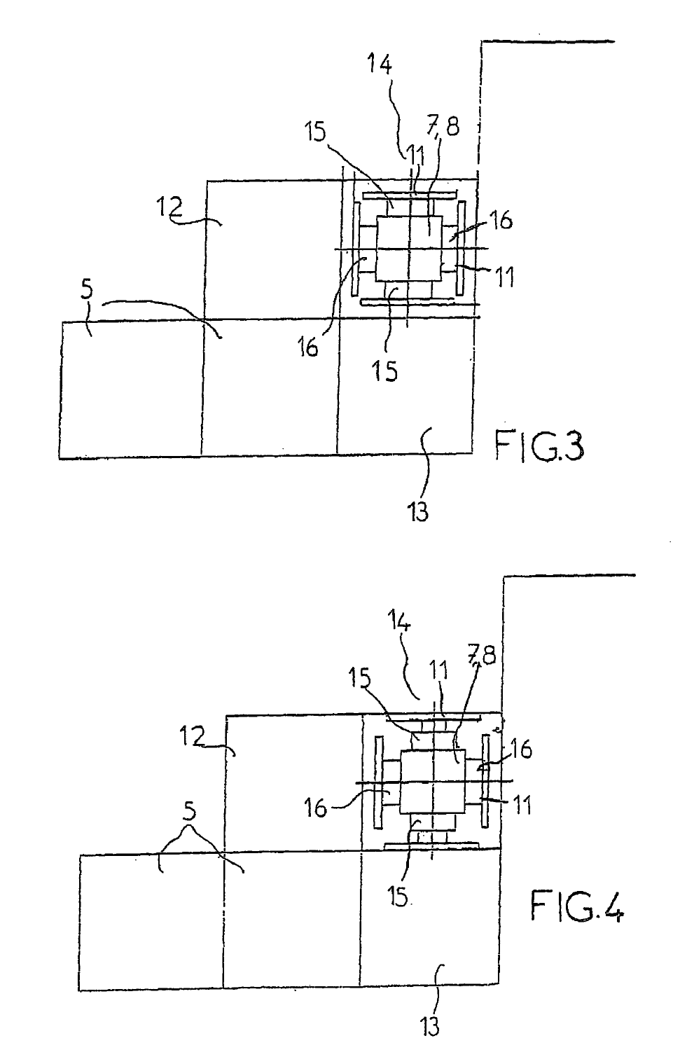

FIG. 3 is a schematic representation illustrating in transverse cross section the positioning of the tool in retracted position.

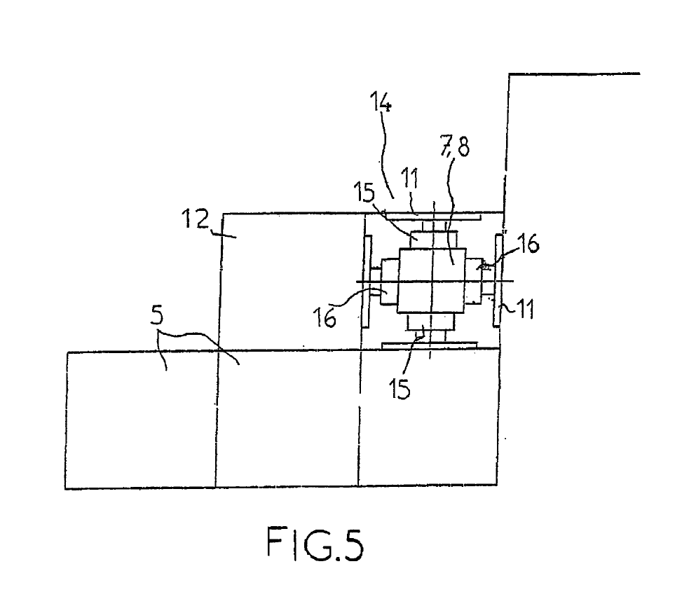

FIG. 4 is a view similar to FIG. 3, in the partially developed position.

FIG. 5 is a view similar to FIG. 3, in the fully developed position.

Therefore, FIGS. 1 and 2 represent the tool according to the invention, according to a first particular embodiment.

This tool, as previously mentioned, is intended to be handled either by the nuclear fuel assembly refueling machine or by an independent tool, specifically dedicated to the operation of this tool. arranged for the handling and storage of the tool.

In the first case, one of the masts of the machine is arranged for the handling and storage of the tool, which, in the refueling phase, remains permanently within the machine, and which may be removed after the loading and placed in a container to be transferred and used on other sites.

In the second alternative, in the reloading phase, the tool and the elements necessary for its operation are stored in the reactor building on the transfer side. If required, the tool is gripped by means of a grab (3) which may be either the fuel handling grab of the refueling machine or a grab secured to an ancillary handling means. This grab is secured, usually in reversible manner, to the bottom end of a handling mast (2).

This tool, in the embodiment described, comprises different actuators (7), (8), mounted on a rigid structure (9), of a height equivalent to the height of a fuel assembly (5).

This rigid structure (9) is furnished at its bottom end with positioning pins (10) intended to be placed at the orifices provided for this purpose, and in each of the fuel assembly locations made in the core plate (1).

In this way, the tool is held at both its ends, respectively on the core plate and at its top end, by the handling mast (by means of the grab (3) reversibly secured to the head (4) of the tool), giving thereto a reference point in the plane (X, Y), that is to say in the horizontal plane, and furthermore, a greater mechanical strength, in the context of the operation of the actuators, and therefore a greater effectiveness.

Advantageously, the tool comprises an actuator, called a “head” actuator, referenced (7), intended to act on the head of the intermediate assembly or assemblies. It also comprises other actuators (8), distributed over the height of the structure, and advantageously positioned level with the spacer grids (6) of said intermediate fuel assemblies (5).

However, and in order to better distribute the pressure of said actuators, the structure also comprises pressure distribution metal sheets (11), extending over the whole height of the structure, as can well be seen in FIGS. 1 and 2, secured to the actuators, and parallel to the sides of the assemblies or baffles onto which they are intended to press.

These metal sheets are typically made out of stainless steel and are, where necessary, reinforced by internal reinforcement elements (not shown), in order to better withstand the pressures to which they are subjected by the actuators during operation.

The actuators will be described hereinafter in greater detail.

As can be seen in FIGS. 3, 4 and 5, they have a horizontal travel, in directions perpendicular to the sides of the square cross sections defining the fuel assemblies, in North-South and East-West directions.

They consist typically of electric, pneumatic, mechanical or even hydraulic cylinders (15, 16).

The stroke of each of these means is approximately 3 cm, such that, when the tool is in retracted position, it may be inserted relatively easily inside a vacant fuel assembly position in order to be able to perform its function, without friction on contact with the adjacent fuel assemblies.

Thus, in FIG. 3, the tool is represented in fully retracted position and the clearance allowing the tool to be inserted without friction on the assemblies already in place can be seen.

In FIG. 4, the represented actuator is deployed (15) on two opposite faces pressing on a baffle (14) on the one hand, and on the intermediate assembly (13), in order to push away the assembly (13) having a deformation preventing the insertion of the assembly into which the tool is inserted.

The actuator is arranged so as to be able to develop a force of approximately 500 daN, sufficient to push away an intermediate fuel assembly, even a set of assemblies, insofar as the dimensions in the volume of the location into which the tool is placed may result on the one hand from an immediately adjacent assembly but also from accumulated deformations in a line of assemblies.

The forces to be applied may be of different intensity depending on the zones of action, particularly at the head or at the fuel rods, and on the pressures tolerated by the different items of equipment.

FIG. 5 shows an actuator deployed on its four faces in order to be able to push away the assembly (12) and the assembly (13).

In the case of an installation of an assembly inside a location delimited by only three other assemblies already in place, the force applicable on the assembly having no opposing assembly is proportional to the nominal force likely to be developed by the actuator, reduced by the coefficient of friction of said actuator on the other two assemblies.

It is evidently conceivable that the actuators may be mobilized independently of one another in order to straighten the assembly or the wall of deformed assemblies.

When the operation is complete, the tool is retracted and cleared away to its waiting location.

The fuel assembly of the location concerned may then be inserted in conventional manner by the refueling machine.

Therefore all the value of the tool according to the invention is evident since it makes it possible in a simple and rapid manner to release the location of an assembly in question.

According to an embodiment not shown, the tool according to the invention may have only one actuator (7) acting solely on the head of the intermediate fuel assemblies. On this hypothesis, the tool has no rigid structure (9) and therefore does not press on the core plate (1).

1. A tool for assisting loading of nuclear fuel assemblies (5) inside a reactor core, said assemblies having a prismatic shape and square cross section, and being positioned on a plurality of adjacent locations, also with square cross section, each comprising, positioning pins and orifices for circulating a liquid coolant and in particular water, comprising at least one actuator which, in retracted position, has a space requirement less than that of a fuel assembly, said actuator being provided with actuating means to act on intermediate fuel assemblies and/or on intermediate reactor vessel baffles of a location concerned at which it is being loaded, said actuator being furnished with gripping means intended to interact with a grab of a handling mast used to load same at the location concerned.

2. The tool for assisting loading of nuclear fuel assemblies inside a reactor core as claimed in claim 1, wherein the actuating means act on a plane perpendicular to a main direction of the fuel assembly, and in particular in four directions perpendicular to sides of a square defining a cross section of each of the assembly locations.

3. The tool for assisting loading of nuclear fuel assemblies (5) inside a reactor core as claimed in claim 2, wherein action of the actuating means, is carried out simultaneously in the four directions perpendicular to the sides of the square defining the cross section of each of the assembly locations, or in successive manner two by two.

4. The tool for assisting loading of nuclear fuel assemblies (5) inside a reactor core as claimed in claim 1, the actuating means comprises mechanical, electric, pneumatic or hydraulic cylinders.

5. The tool for assisting loading of nuclear fuel assemblies inside a reactor core as claimed in claim 4, wherein the cylinders are actuated automatically or are controlled by means of a control console situated either at an edge of a vessel cavity, or at the refueling machine.

6. The tool for assisting loading of nuclear fuel assemblies inside a reactor core as claimed in claim 1, wherein the tool extends over a whole height of the fuel assembly and can be positioned on a core plate and be anchored thereon, more particularly on the positioning pins with which the latter is provided by means of an internal structure.

7. The tool for assisting loading of nuclear fuel assemblies inside a reactor core as claimed in claim 6, comprising several actuators, distributed over its height and attached to the internal structure.

8. The tool for assisting loading of nuclear fuel assemblies inside a reactor core as claimed in claim 6, further comprising pressure distribution metal sheets which are flat and mounted parallel to the sides of the intermediate assemblies, and extending over the whole height of the tool, secured to the end of the actuating means, and intended to press against the intermediate fuel assemblies or the intermediate baffles.

9. The tool for assisting loading of nuclear fuel assemblies inside a reactor core as claimed in claim 8, wherein the pressure distribution metal sheets are reinforced locally by any appropriate reinforcement device.

10. The tool for assisting loading of nuclear fuel assemblies inside a reactor core as claimed in claim 1, comprising only one actuator intended to act only at heads of the intermediate fuel assemblies.
